(19) United States
(12) Patent Application Publication
(10) Pub. No.: US 2024/0256769 A1
(43) Pub. Date: Aug. 1, 2024

(54) MedSpell

(71) Applicant: Jacque Young, Louisville, KY (US)

(72) Inventor: Jacque Young, Louisville, KY (US)

(73) Assignee: Young Jacque, LOUISVILLE, KY (US)

(21) Appl. No.: 18/103,972

(22) Filed: Jan. 31, 2023

(51) Int. Cl. G06F 40/232; G06F 21/62; G06F 40/242

(52) U.S. Cl. CPC G06F 40/232; G06F 21/6245; G06F 40/242

(57) ABSTRACT

The objective of Medspell application is to create an integration of Custom keyboard for IOS and Android to make all medical terminology easy to write with an autocorrect feature. This also includes a medical dictionary as google extension to enhance the feature of Google and Microsoft browser. Purpose will be for medical practitioners, medical students, ancillary staff, and others who want to write messages, blogs, Journals, emails etc using medical terms on digital platforms like whatsapp messenger, snapchat, all emails, twitter, facebook, imessage, google chat, and more. The mobile app Custom Keyboard main purpose is to use medical dictionary for writing text with an autocorrect and voice to text features on mobile apps in IOS and Android platform. Users can add the keyboard as an extension app from apple store/playstore which would work as native keyboard like others already available. Medical Dictionary as Google Extension/App with same functionalities. Users can use the dictionary to search the medical terms with autocorrect features by text or voice without remembering spelling. The app will provides real time medical terms suggestions and spell correct options. Both will have backend Medical terms data to get the word correct automatically, and provide options to replace the word by the input method supported by the operating system. Also will have added features for the user to add new medical terms to store into the database for further use. The dictionary (and the application) can be upgraded from time to time for adding new medical words.

### OBJECTIVE

The objective of this project is to provide
1. An integration of Custom keyboard for IOS and Android to make all medical terminology easy to write with an autocorrect feature.
2. Create the same medical dictionary as google extension to enhance the feature of Google browser

This would be a gamechanger for medical people who want to write messages, blogs, Journals, emails etc using medical terms on digital platforms like whatsapp messenger, snapchat, gmail, twitter, facebook and more.

### SCOPE

Mobile app Custom Keyboard to use medical dictionary for writing text with an autocorrect and voice to text features on mobile apps in IOS and Android platform. Users can add the keyboard as an extension app from apple store/playstore which would work as native keyboard like others already available, but this is for medical practitioners.

Medical Dictionary as Google Extension/App with same functionalities. Users can use the dictionary to search the medical terms with autocorrect features by text or voice without remembering spelling, It provides real time medical terms suggestions and spell correct options.

Both will have backend Medical terms data to get the word correct automatically, and provide options to replace the word by the input method supported by the operating system. Also will have added features for the user to add new medical terms to store into the database for further use. The dictionary (and the application) can be upgraded from time to time for adding new medical words.

In general, this project has good potential which includes that Data can be used for AI for smart medical solutions.

1. MedSpell app will provide real-time medical words spelling check. The way the app will work is when you start typing, the closest words start appearing to helps to write correct spelling, with a hold of the button a word can get corrected word replacement options. The medical dictionary database will integrate with the keyboard having features like autocorrect and speech to text. We upgrade and add the words to the dictionary provided by the client from time to time. The application will include Integrate Native Speech to Text functionality, an add feature to update new words automatically to the database. There will be the ability to connect with all open apps and be used as default. Words will be added by the authorized medical practitioners so accuracy will be 100%. The user can add small details about the terms with a long press display on any word. Users will be given functionality to add word to the dictionary. There will be a privacy Feature—A custom keyboard gives you access to what a user types. You should therefore establish and maintain their trust by being visible about privacy policies. Users should be assured that their keystroke data will only be used for the document they are typing and not for other purposes not obvious to them. A key feature of the mobile app—Next keyboard to switch the keyboard like in default system keyboard there is a globe icon for switching of the keyboard. Google Extension/Apps We will provide the same functionalities for google browser under apps or as extension which will help to write blogs, journals, emails, prescription whichever supported by google browser.
